(19) United States
(12) Patent Application Publication
(10) Pub. No.: US 2019/0197913 A1
(43) Pub. Date: Jun. 27, 2019

(54) INFORMATION PROCESSING APPARATUS, INFORMATION PROCESSING METHOD, AND NON-TRANSITORY RECORDING MEDIUM RECORDED WITH PROGRAM

(71) Applicant: KYOCERA Document Solutions Inc., Osaka (JP)

(72) Inventor: Keiji Sakabe, Osaka (JP)

(21) Appl. No.: 16/228,371

(22) Filed: Dec. 20, 2018

(30) Foreign Application Priority Data
Dec. 27, 2017 (JP) 2017-251595

(51) Int. Cl. G09B 7/08; G06F 3/147

(52) U.S. Cl. CPC G09B 7/08; G06F 3/147

(57) ABSTRACT

An information processing apparatus includes an answer acquiring portion, an answering time acquiring portion, a scoring processing portion, and an information presenting portion. The answer acquiring portion acquires an answer and a solution of a user to a problem. The answering time acquiring portion acquires an answering time of the user taken for the problem. The scoring processing portion scores the answer. The information presenting portion presents, to the user, information which is determined based on the answering time acquired by the answering time acquiring portion, a result of scoring the answer performed by the scoring processing portion, and the solution acquired by the answer acquiring portion.

### INCORPORATION BY REFERENCE

This application is based upon and claims the benefit of priority from the corresponding Japanese Patent Application No. 2017-251595 filed on Dec. 27, 2017, the entire contents of which are incorporated herein by reference.

### BACKGROUND

The present disclosure relates to an information processing apparatus, an information processing method, and a recording medium recorded with a program that support the learning of learners.

In recent years, education using ICT (Information and Communication Technology) is popular. For example, in a school, tablet terminals used by students are connected via a network to a personal computer used by a teacher and information is exchanged bidirectionally between them. For example, when the students input answers to a problem displayed on the tablet terminals, the personal computer acquires an answering result. The teacher prepares information for supporting the learning of the students, by using the personal computer based on the answering result, and transmits the information the tablet terminals of the students.

### SUMMARY

An information processing apparatus according to an aspect of the present disclosure includes an answer acquiring portion, an answering time acquiring portion, a scoring processing portion, and an information presenting portion. The answer acquiring portion acquires an answer and a solution of a user to a problem. The answering time acquiring portion acquires an answering time of the user taken for the problem. The scoring processing portion scores the answer. The information presenting portion presents, to the user, information which is determined based on the answering time acquired by the answering time acquiring portion, a result of scoring the answer performed by the scoring processing portion, and the solution acquired by the answer acquiring portion.

An information processing method according to another aspect of the present disclosure includes: acquiring an answer and a solution of a user to a problem; acquiring an answering time of the user taken for the problem; scoring the answer; and presenting, to the user, information which is determined based on the answering time acquired, a result of the scoring the answer, and the solution acquired.

A recording medium according to a further aspect of the present disclosure is a non-transitory computer-readable recording medium recorded with a program that causes a computer to execute: a step of acquiring an answer and a solution of a user to a problem; a step of acquiring an answering time of the user taken for the problem; a step of scoring the answer; and a step of presenting, to the user, information which is determined based on the answering time acquired, a result of the scoring the answer, and the solution acquired.

This Summary is provided to introduce a selection of concepts in a simplified form that are further described below in the Detailed Description with reference where appropriate to the accompanying drawings. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a diagram showing a schematic configuration of an information processing system according to an embodiment of the present disclosure.

FIG. 2 is a functional block diagram showing a configuration of the information processing system according to the embodiment.

FIG. 3 is a diagram showing an example of a table stored in a problem database according to the embodiment.

FIG. 4 is a diagram showing an example of a table stored in a solution database according to the embodiment.

FIG. 5 is a diagram schematically showing a table stored in a storage portion according to the embodiment.

FIG. 6 is a flowchart showing an example of a procedure of information processing performed by an information processing apparatus according to the embodiment.

FIG. 7 is a diagram showing an example of a summary table stored in the storage portion according to the embodiment.

FIG. 8 is a diagram showing another configuration of the information processing system according to the embodiment.

### DETAILED DESCRIPTION

The following describes an embodiment of the present disclosure with reference to the accompanying drawings. It should be noted that the following embodiment is an example of a specific embodiment of the present disclosure and should not limit the technical scope of the present disclosure.

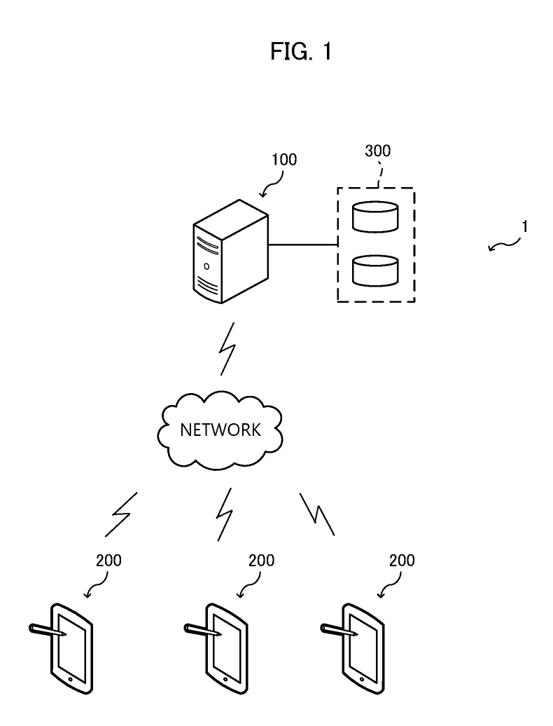

FIG. 1 is a diagram showing a schematic configuration of an information processing system 1 according to the present embodiment.

The information processing system 1 includes a server 100 (hereafter referred to as “information processing apparatus 100”), a database device 300 (hereafter referred to as “database 300”) connected to the information processing apparatus 100 via a network, and a plurality of user terminals 200 (hereafter referred to as “learner terminals 200”) connected to the information processing apparatus 100 via the network. The network is a communication network such as the Internet, a wired LAN or a wireless LAN. The information processing system 1 is applicable to, for example, a learning support system that is introduced into education in schools, and an online learning support system that is provided through the Internet. Users (hereafter referred to as “learners”) perform learning by using the learner terminals 200 to exchange information with the information processing apparatus 100. In the following description, it is supposed that the learner terminals 200 are tablet terminals. However, the learner terminals 200 are not limited to the tablet terminals, but may be smartphones, personal computers, mobile information terminals or the like.

In the following description, it is supposed that the information processing system 1 is adopted as a learning support system for education in a school. In the information processing system 1, the information processing apparatus 100 and the database 300 are devices installed in the school, and the learner terminals 200 are devices that are used by the students. The information processing apparatus 100, the database 300, and the learner terminals 200 are connected to each other via a LAN installed in the school. The database 300 may be included in the information processing apparatus 100. It is noted that the information processing apparatus 100 and the database 300 may be installed outside the school, and may be connected to the learner terminals 200 via the Internet.

Meanwhile, there is known a system for acquiring stroke data corresponding to a character string handwritten on a tablet terminal by a student who is solving a problem, determining a handwriting state of the student based on feature amounts extracted from the stroke data, and using the determination result to guide the learning of the student. According to the system, however, a teacher is required to guide a plurality of students one by one based on the data acquired from a plurality of tablet terminals. This is not efficient for learning. In addition, there may be two or more solutions to a problem presented to a student. In that case, when a student has answered correctly by using a solution, it is desirable that another solution (for example, an efficient solution) is presented to the student to improve his/her learning ability. In this respect, the information processing system 1 of the present embodiment is configured to support the learning of the learners efficiently.

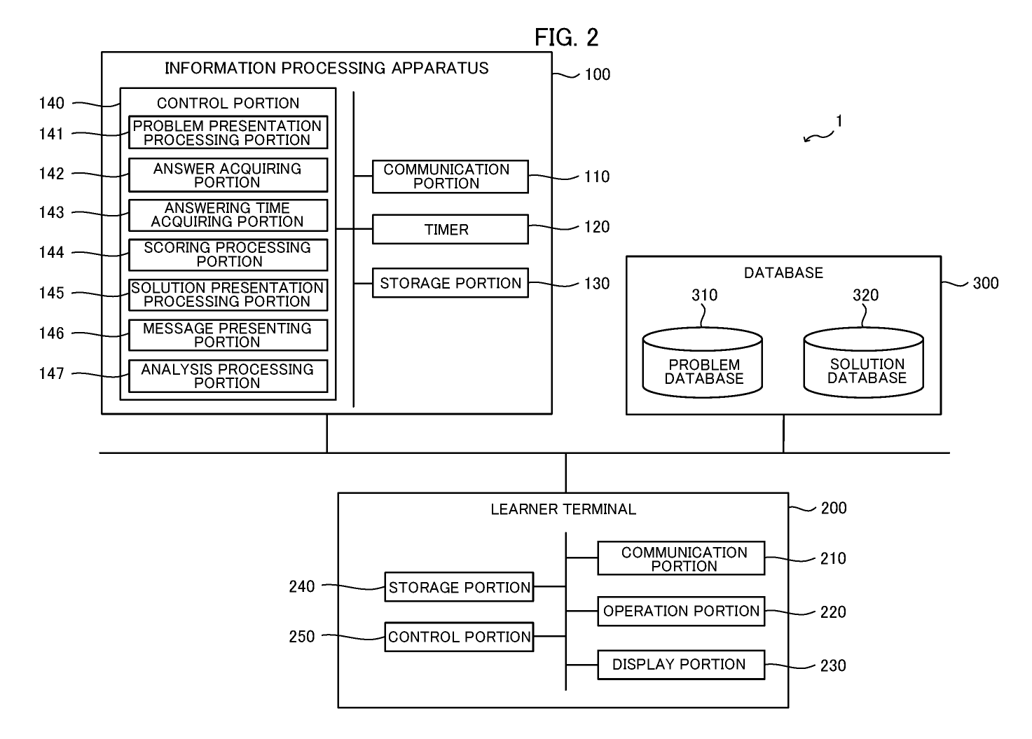

FIG. 2 is a functional block diagram showing a configuration of the information processing system 1 according to the present embodiment. The information processing apparatus 100 includes a communication portion 110, a timer 120, a storage portion 130, and a control portion 140.

The communication portion 110 is a communication interface for communicating with, and transmitting and receiving data (information) to/from, the database 300 and the learner terminals 200. Specifically, the information processing apparatus 100 is configured to, via the communication portion 110, acquire various types of information (problem information, solution information, etc.) from the database 300, store various types of information in the database 300, and update the various types of information stored in the database 300. In addition, the information processing apparatus 100 is configured to transmit the problem information (hereafter, merely referred to as a “problem”), the solution information (hereafter, merely referred to as a “solution”), and various types of messages to the learner terminals 200 via the communication portion 110. Furthermore, the information processing apparatus 100 is configured to acquire, via the communication portion 110, various types of information, such as an answer and a solution to a problem, from the learner terminals 200 operated by the learners.

The timer 120 measures the time according to an instruction (order) from the control portion 140. For example, the timer 120 measures an answering time t1, the time taken by a learner to find an answer to a problem. Specifically, for example, the timer 120 measures a time period from when a problem is presented (transmitted) to a learner terminal 200 to when a learner's answer to the problem is acquired (received) from the learner terminal 200. The control portion 140 acquires the time (answering time t1) measured by the timer 120. It is noted that the answering time t1 is not limited to the above-described time period.

The storage portion 130 stores, based on an instruction from the control portion 140, an answer and a solution acquired from a learner terminal 200. In addition, the storage portion 130 stores the time (answering time t1) measured by the timer 120 based on an instruction from the control portion 140. Furthermore, one or more solutions and a reference answering time t0 are registered in association with a problem in the database 300 in advance, and the one or more solutions and the reference answering time t0 are acquired from the database 300 and stored in the storage portion 130 based on an instruction from the control portion 140. The various types of information stored in the storage portion 130 may be added, deleted, and/or updated by the control portion 140.

The control portion 140 includes a problem presentation processing portion 141, an answer acquiring portion 142, an answering time acquiring portion 143, a scoring processing portion 144, a solution presentation processing portion 145 (information presenting portion), a message presenting portion 146 (information presenting portion), and an analysis processing portion 147.

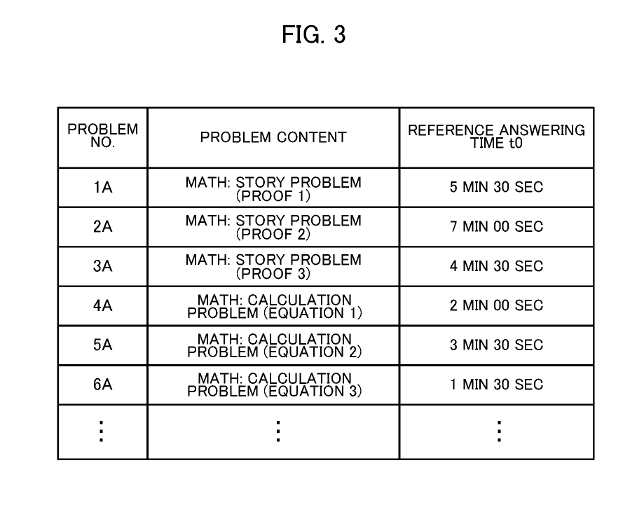

The problem presentation processing portion 141 presents a problem to the learner terminals 200. The problem is stored in a problem database 310 of the database 300 in advance. Specifically, a plurality of problems are stored in the problem database 310 in association with a plurality of model answers to the problems and a plurality of reference answering times t0 that each serve as a reference of an answering time to a problem. The problem database 310 stores a table (see FIG. 3) in which these types of information are stored in association with each other. FIG. 3 shows a table composed of a plurality of pieces of information in each of which a problem number, content of the problem, and the reference answering time t0 are stored in association with each other. The reference answering time t0 may be set by a teacher in advance, or may be set by the control portion 140 in advance based on answering times of students in the past. FIG. 3 shows problems of mathematics as one example, but the course (subject) of problem is not limited to mathematics, but may be science, national language, English or the like.

The problem presentation processing portion 141 acquires a problem from the problem database 310 and transmits the problem to the learner terminals 200, via the communication portion 110. In addition, the problem presentation processing portion 141 acquires a reference answering time t0 for the problem from the problem database 310 via the communication portion 110 and stores the reference answering time t0 in the storage portion 130.

The answer acquiring portion 142 acquires an answer and a solution of a learner to the problem from a learner terminal 200 via the communication portion 110 and stores the acquired solution and answer in the storage portion 130.

The answering time acquiring portion 143 instructs the timer 120 to start and end measuring the answering time. In addition, the answering time acquiring portion 143 acquires, from the timer 120, an answering time t1 measured by the timer 120 and stores the answering time t1 in the storage portion 130.

The scoring processing portion 144 determines (scores) whether or not the answer of the learner is correct (whether the answer is correct or wrong). For example, the scoring processing portion 144 determines whether the answer of the learner is correct or wrong by comparing the answer of the learner stored in the storage portion 130 with a corresponding model answer stored in the problem database 310. The scoring processing portion 144 stores the scoring result (indicating whether the answer is correct or wrong) in the storage portion 130.

The solution presentation processing portion 145 presents, to the learner, the scoring result and a solution to the problem that has been registered in advance. The solution indicates a method and a procedure for solving the problem. There may be one solution or a plurality of solutions to one problem. In addition, there may be no solution to particular types of problems such as a simple calculation problem and a problem that needs only memorizing. In a case where there are a plurality of solutions, the plurality of solutions may include a general solution, an efficient (easy) solution, an exceptional solution or the like. The general solution is, for example, a representative solution that may be taught by a teacher during a class. The efficient solution is, for example, a solution that leads to an answer in a short time, or easily. The exceptional solution is a solution other than these solutions. It is noted that the solution is not limited to a method and a procedure for solving the problem, but may be a point (a guideline, a hint, a way of thinking or the like) to solve the problem.

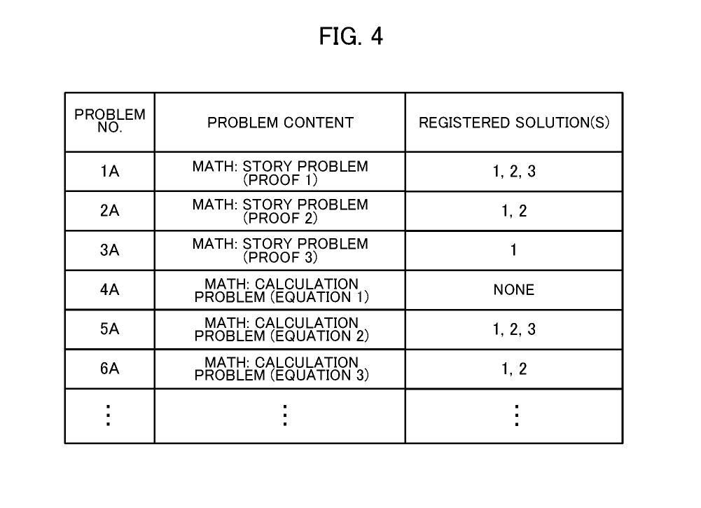

The solutions are stored in a solution database 320 of the database 300 in advance. Specifically, a plurality of problems are stored in the solution database 320 in association with a plurality of solutions to the problems. The solution database 320 stores a table (see FIG. 4) in which these types of information are stored in association with each other. FIG. 4 shows a table composed of a plurality of pieces of information in each of which a problem number, content of the problem, and a solution(s) to the problem are stored in association with each other. The solution(s) may be registered by a teacher in advance, or may be registered by the control portion 140 in advance based on solutions of students in the past. In the example shown in FIG. 4, three solutions (“solution 1”, “solution 2” and “solution 3”) are registered in association with a problem 1A. In addition, “no solution” is registered in association with a problem 4A, meaning that there is no solution to the problem.

The solution presentation processing portion 145 acquires a solution(s) associated with a problem that has been acquired from the problem database 310 by the problem presentation processing portion 141, from the solution database 320 (see FIG. 4) via the communication portion 110, and stores the solution(s) in the storage portion 130. In addition, the solution presentation processing portion 145 determines whether or not there is another solution(s) to the problem (whether or not another solution(s) is registered), by consulting the storage portion 130. The solution presentation processing portion 145, based on the determination result, acquires a solution(s) to be presented to a learner, from the storage portion 130, and transmits the solution(s) to the learner terminal 200 of the learner. It is noted that the solution presentation processing portion 145 selects the solution(s) to be presented to the learner, from a plurality of registered solutions based on the answer of the learner, the answering time t1 that the learner took to find the answer, and a solution selected by the learner. In addition, the solution presentation processing portion 145 acquires a scoring result from the storage portion 130 and transmits it to the learner terminal 200 of the learner.

The message presenting portion 146 transmits various types of messages to the learner terminals 200 via the communication portion 110. The messages are stored in the database 300 or the storage portion 130 in advance. The messages are, for example, registered by a teacher in advance. The message presenting portion 146 transmits, to the learner terminal 200 of the learner, a message that is selected from a plurality of registered messages based on the answer and solution, the scoring result, and the answering time t1 of the learner. Specific contents of the messages are described below.

The analysis processing portion 147 sums up and analyzes answers and solutions, scoring results, and the answering times t1 of one or more learners. Based on the analysis results, the control portion 140 classifies problems and solutions, and calculates tendency of the learners' answers. A specific example of the processing performed by the analysis processing portion 147 is described below.

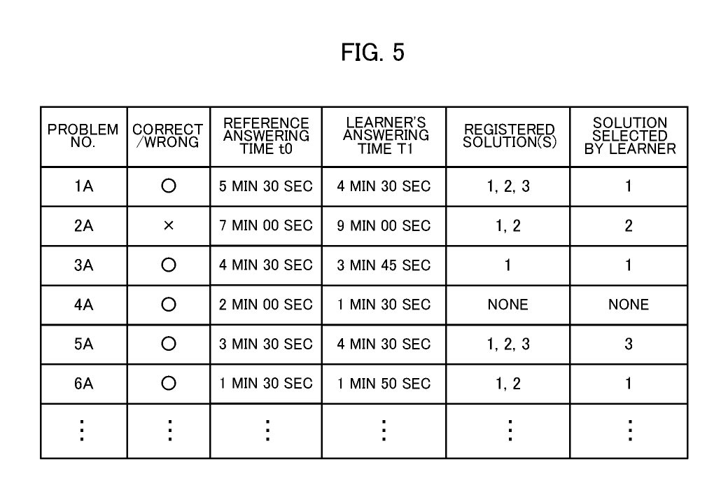

FIG. 5 shows a table storing various types of information in association with each other, wherein the information is registered in the storage portion 130 during the above-described processes of the control portion 140. The table is stored in the storage portion 130. The table shown in FIG. 5 is composed of a plurality of pieces of information in each of which a problem number, a reference answering time to, an answering time t1 of a learner, a scoring result (correct or wrong), a solution registered in advance for the problem, and a solution selected by the learner, are stored in association with each other.

The control portion 140 includes a CPU, a ROM, and a RAM. The control portion 140 also includes a non-volatile storage portion (not shown) such as an EEPROM. The CPU is a processor that executes various calculation processes. The control portion 140 causes the CPU to execute the processes in accordance with programs stored in the ROM or the storage portion. This allows the control portion 140 to control the information processing apparatus 100. The control portion 140 functions as the problem presentation processing portion 141, the answer acquiring portion 142, the answering time acquiring portion 143, the scoring processing portion 144, the solution presentation processing portion 145, the message presenting portion 146, and the analysis processing portion 147 as the CPU executes the processes in accordance with the programs stored in the ROM. It is noted that any one or more of the problem presentation processing portion 141, the answer acquiring portion 142, the answering time acquiring portion 143, the scoring processing portion 144, the solution presentation processing portion 145, the message presenting portion 146, and the analysis processing portion 147 may be an electronic circuit(s) such as ASIC(s). The programs may be recorded on a computer-readable non-transitory recording medium, such as a CD-ROM, a DVD-ROM, or a memory card, and installed into the information processing apparatus 100 from the recording medium. In addition, the programs may be downloaded from a communication network such as the Internet. The programs may be stored in a server provided outside the information processing apparatus 100, and executed on a cloud.

As shown in FIG. 2, each of the learner terminals 200 includes a communication portion 210, an operation portion 220, a display portion 230, a storage portion 240, and a control portion 250.

The communication portion 210 is a communication interface for communicating with, and transmitting and receiving data (information) to/from, the information processing apparatus 100. Specifically, each of the learner terminals 200 receives problems, solutions, various types of messages and the like from the information processing apparatus 100 via the communication portion 210. In addition, the learner terminal 200 transmits various types of information, such as an answer and a solution of a learner, to the information processing apparatus 100 via the communication portion 210, in accordance with an operation by the learner.

The operation portion 220 receives operations of the learner. The operation portion 220 is, for example, a touch panel. However, not limited to this, the operation portion 220 may be a keyboard, a mouse or the like.

The display portion 230 is a display panel for displaying various types of information based on instructions from the control portion 250. For example, the display portion 230 displays the above-mentioned problems, answers, solutions, messages and the like.

The storage portion 240 stores various types of information that the learner terminal 200 has acquired from the information processing apparatus 100. In addition, the storage portion 240 stores various types of programs for causing the CPU of the control portion 250 to execute various processes.

The control portion 250 controls the portions of the learner terminal 200. For example, the control portion 250 displays, on the display portion 230, a problem, a solution, a message or the like received from the information processing apparatus 100 via the communication portion 210. In addition, the control portion 250 transmits an answer and a solution that were input into the learner terminal 200 by a learner through the operation portion 220, to the information processing apparatus 100 via the communication portion 210.

A known configuration can be applied to the learner terminal 200.

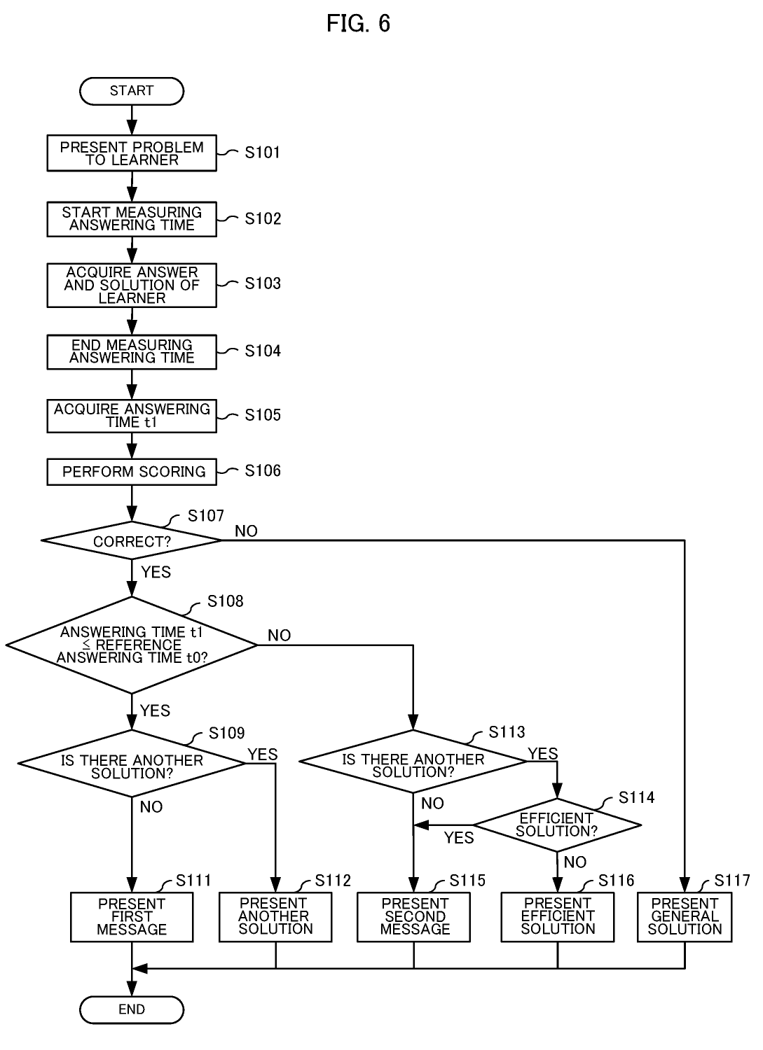

Next, an example of a procedure of information processing performed by the information processing apparatus 100 is described with reference to FIG. 6. It is noted that the following description of the information processing pays attention to a learner A. An information processing method that executes one or more steps included in the information processing may be construed as an aspect of the present invention.

First, the problem presentation processing portion 141 acquires a problem (for example, the problem 1A) to be presented to the learner A, from the problem database 310 (see FIG. 3), and transmits the problem to the learner terminal 200 (step S101, hereafter merely represented as “S101”). This allows the problem 1A to be displayed on the display portion 230 of the learner terminal 200.

In this example, it is supposed that three solutions (“solution 1”, “solution 2” and “solution 3”) are registered in advance for the problem 1A in the solution database 320, wherein it is supposed that the solution 1 is a general solution, the solution 2 is an efficient solution, and the solution 3 is an exceptional solution. It is further supposed that the learner A has selected the solution 1 to reach an answer to the problem 1A.

Subsequently, the answering time acquiring portion 143 instructs the timer 120 to start measuring the answering time. For example, the answering time acquiring portion 143 instructs the timer 120 to start measuring the answering time at a timing when the problem presentation processing portion 141 transmits the problem 1A to the learner terminal 200. This allows the timer 120 to start measuring the answering time (S102).

It is noted that the timing for starting measurement of the answering time is not limited to the above-described timing. For example, in a case where the problem 1A is displayed on the display portion 230 when the learner A presses a start button after the learner terminal 200 acquires (receives) the problem 1A, the measurement of the answering time may be started at a timing when the information processing apparatus 100 receives, from the learner terminal 200, information that the start button has been pressed.

Next, the answer acquiring portion 142 acquires an answer and a solution (in this example, the solution 1) to the problem 1A from the learner terminal 200 via the communication portion 110 and stores the answer and solution in the storage portion 130 (S103). For example, the control portion 250 of the learner terminal 200 acquires an answer and a solution (the solution 1) that were input into the learner terminal 200 by the learner A operating the operation portion 220, and transmits them to the information processing apparatus 100.

It is noted that the control portion 250 may transmit an answer and a solution (the solution 1) to the information processing apparatus 100 at a timing when the learner terminal 200 receives from the learner A a notification that he/she has finished answering the problem, the notification being sent when the learner A presses an answering finish button for the problem 1A displayed on the learner terminal 200.

When the learner A finishes the answering operation, the answering time acquiring portion 143 instructs the timer 120 to end measuring the answering time. For example, the answering time acquiring portion 143 instructs the timer 120 to end measuring the answering time at a timing when the scoring processing portion 144 receives the answer and the solution (“solution 1”) from the learner terminal 200. This allows the timer 120 to end measuring the answering time (S104). It is noted that the answering time acquiring portion 143 may instruct the timer 120 to end measuring the answering time at a timing when the information processing apparatus 100 receives, from the learner terminal 200, information that the finish button has been pressed.

Subsequently, the answering time acquiring portion 143 acquires the answering time t1 measured by the timer 120, from the timer 120, and stores the answering time t1 in the storage portion 130 (S105).

Subsequently, the scoring processing portion 144 scores the answer of the learner (S106), and determines whether or not the answer of the learner A is correct (whether the answer is correct or wrong) (S107). For example, the scoring processing portion 144 determines whether the answer of the learner A is correct or wrong by comparing the answer of the learner A stored in the storage portion 130 with a corresponding model answer stored in the problem database 310. The scoring processing portion 144 stores the scoring result (indicating whether the answer is correct or wrong) in the storage portion 130.

When it is determined that the answer of the learner A is correct (S107: YES), the solution presentation processing portion 145 determines whether or not the answering time t1 of the learner A is equal to or less than the reference answering time t0 (t1≤t0) by consulting the storage portion 130 (see FIG. 5) (S108). In this example, the answering time t1 (=4 minutes 30 seconds) is determined to be equal to or less than the reference answering time t0 (=5 minutes 30 seconds) (S108: YES), and the process moves to S109.

Subsequently, in S109, the solution presentation processing portion 145 determines whether or not there is another solution to the problem 1A. In this example, since three solutions (“solution 1”, “solution 2” and “solution 3”) are registered in association with the problem 1A, it is determined that there is another solution (“solution 2”, “solution 3”) to the problem 1A (S109: YES), and the process moves to S112.

In S112, the solution presentation processing portion 145 presents the scoring result of the learner A's answer and another solution to the learner A. For example, the solution presentation processing portion 145 acquires the scoring result (“correct”) and a solution (“solution 2” or “solution 3”) that is different from the solution (“solution 1”) selected by the learner A, from the storage portion 130, and transmits them to the learner terminal 200 of the learner A. This allows the display portion 230 of the learner terminal 200 of the learner A to display the scoring result (“correct”) and another solution (“solution 2” or “solution 3”) to the problem 1A. It is noted that in a case where there are a plurality of other solutions, the solution presentation processing portion 145 may transmit any one of them to the learner terminal 200, or transmit two or more of them to the learner terminal 200.

According to the above-described processing, even if the learner A finds a correct answer within the reference answering time, if there is a solution(s) other than a solution selected by the learner A, the different solution(s) is presented to the learner A. This allows the learner A to obtain a solution(s) (a general solution, an efficient solution, an exceptional solution or the like) that is different from the solution selected by himself/herself, thus making it possible to improve his/her learning ability. In addition, the above-described processing does not require an operation of a teacher, but is executed automatically. This makes it possible to support the learning of the learners efficiently.

When it is determined in S109 of the flowchart shown in FIG. 6 that there is no other solution to the problem 1A (S109: NO), the message presenting portion 146 transmits a predetermined message (first message) to the learner terminal 200 via the communication portion 110 (S111). For example, the message presenting portion 146 may transmit, as the first message, a message that praises the learner A (e.g., “Well done”, “You answered (found a correct answer) within the reference answering time”). This falls under the case where there is no solution to a problem, as in the case of the problem 4A shown in FIG. 4.

When it is determined in S108 of the flowchart shown in FIG. 6 that the answering time t1 of the learner A exceeds the reference answering time t0 (t1>t0) (S108: NO), the process moves to S113. In S113, the same process as that of S109 is performed. When it is determined that there is another solution to the problem 1A (S113: YES), the process moves to S114; and when it is determined that there is no other solution to the problem 1A (S113: NO), the process moves to S115.

In S114, the solution presentation processing portion 145 determines whether or not the solution selected by the learner A is an efficient solution. When it is determined that the solution selected by the learner A is an efficient solution (S114: YES), the process moves to S115; and when it is determined that the solution selected by the learner A is not an efficient solution (S114: NO), the process moves to S116.

In S116, the solution presentation processing portion 145 acquires the scoring result and a solution that is more efficient than the solution selected by the learner A, from the storage portion 130, and transmits them to the learner terminal 200 of the learner A. For example, the solution presentation processing portion 145 acquires the scoring result (“correct”) and the solution 2 that is more efficient than the solution 1 selected by the learner A, from the storage portion 130, and transmits them to the learner terminal 200 of the learner A. This allows the display portion 230 of the learner terminal 200 of the learner A to display the scoring result (“correct”) and an efficient solution to the problem 1A (the solution 2). This allows the learner A to obtain an efficient solution to the problem 1A. Thus, the next time, the learner A is expected to find a correct answer to a similar problem within the reference answering time.

The solution (a first solution) that the solution presentation processing portion 145 present to the learner A in the step S112 may be different from the solution (a second solution) that is presented to the learner A in the step S116 by the solution presentation processing portion 145. For example, the first solution may be an exceptional solution that may serve as a good reference for the learner A, and the second solution may be an efficient (easy) solution that may reduce the answering time of the learner A.

In S115, the message presenting portion 146 transmits a message (a second message) that, for example, encourages the learner A (e.g., “You need concentration to find an answer”, “You have taken so much time to find an answer”). For example, this falls under the case where the learner A selected the “solution 2” and took a time exceeding the reference answering time t0 before finding a correct answer. This allows the learner A to understand that he/she selected a right solution to reach a correct answer, but the answering time was longer than the reference answering time. Thus, the next time, the learner A is expected to improve the answering speed.

When it is determined that the answer of the learner A is wrong (not correct) (S107: NO), the process moves to S117.

In S117, the solution presentation processing portion 145 presents, to the learner A, a result of scoring the answer of the learner A and a general solution. It is noted that the solution presentation processing portion 145 may identify the solution selected by the learner A, and present the solution to the learner A. This allows the learner A to recognize a wrong portion in the solution of his/her own (for example, a clerical error in the middle of the calculation). In addition, the solution presentation processing portion 145 may present, to the learner A, a solution (“solution 2”) that is easier than the solution selected by the learner A.

As described above, according to the information processing apparatus 100 of the present embodiment, it is possible to support the learning of the students without troubling the teacher. In addition, in a case where there are a plurality of solutions to a problem, it is possible to present to a student who found a correct answer, another answer depending on the answering time. It is thus possible to support the learning of the learners efficiently.

In the above example, problems of mathematics are used. However, in the case of questions in national language or English, a plurality of phrases (expressions) may be registered, as a plurality of solutions to a problem. As a result, the information processing apparatus according to the present disclosure is not limited to a specific course, but is applicable to many courses.

An object of the processing may be one problem or a plurality of problems of a course. When a plurality of problems are to be processed, the answering time t1 (S105) is a time period (a total time) from a time when solving the first problem is started to a time when solving the last problem is finished. In addition, the processes of S106 to S117 following S105 are executed for each of the plurality of problems.

The following describes a specific example of the processing of the analysis processing portion 147.

The analysis processing portion 147 sums up answers and solutions, scoring results, and the answering times t1 of the learner A for the plurality of problems, and analyzes the tendency of the learner A's answers (favorite solutions, tendency of the answering time t1, the difficulty level of the problems, and the like). The information processing apparatus 100 executes various types of processes based on the analysis results. For example, when the analysis results show that the learner A tends to select an exceptional solution from a plurality of solutions and has a low correct answer rate, the information processing apparatus 100 may present a general solution or an efficient solution to the learner A. In addition, the problem presentation processing portion 141 may determine, based on the analysis results, a problem to be presented next time to the learner A.

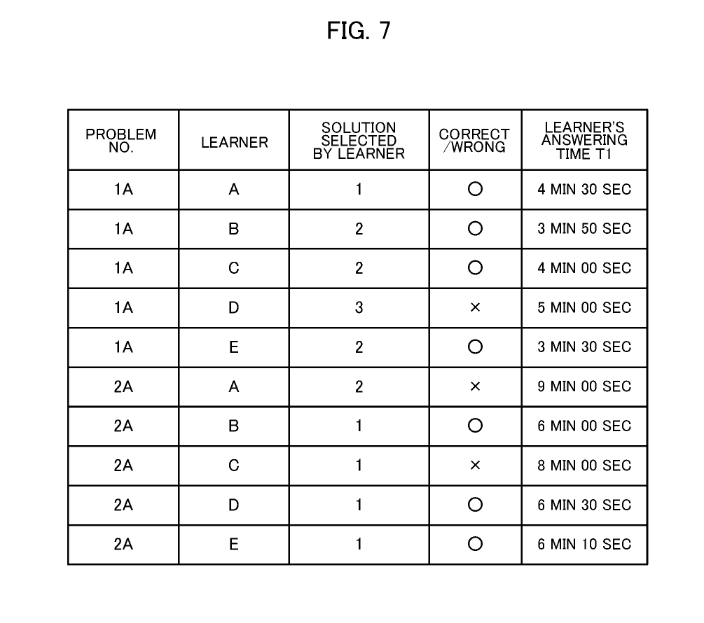

Furthermore, for example, the analysis processing portion 147 sums up answers and solutions, scoring results, and the answering times t1 of a plurality of learners (see FIG. 1), and analyzes the tendency of answers of the plurality of learners (favorite solutions, tendency of the answering time t1, the difficulty level of the problems, and the like). FIG. 7 shows a summary table that stores, with regard to answers of five learners to two problems (“1A”, “2A”), a solution selected by the learner, whether the answer is correct or wrong, and the answering time t1. The summary table is stored in the storage portion 130. The information processing apparatus 100 may present a solution individually to each learner, or present, to each learner, a solution common to the learners, based on the analysis results. For example, in a class S1 of a school, the analysis processing portion 147 may sum up and analyze answers and solutions, scoring results, and the answering times t1 of all students of the class S1, and the teacher may confirm the analysis results. Based on the analysis results, the teacher may transmit various types of information (a solution, explanation or the like) from his/her terminal (personal computer) to terminals (learner terminals 200) of all the students. In addition, based on the analysis results, the information processing apparatus 100 may transmit, to a terminal (learner terminal 200) of each of the students, information that corresponds to the student (a scoring result (correct/wrong), a solution or the like).

The analysis processing portion 147 may, based on the analysis results, update the reference answering time to, set a solution to be registered in the solution database 320, change and update solutions registered in the solution database 320, or determine a problem to be presented to a learner(s).

The information processing apparatus 100 according to the present disclosure is not limited to the above-described configuration.

In the above-described example, a case of the information processing system 1 applied to a learning support system that is introduced into education in schools, is described. In a case where, for example, the information processing system 1 is applied to an online learning support system that is provided through the Internet, the server 100 may be installed in a service provider, and the server 100 may exchange information with the learner terminals 200 via the Internet.

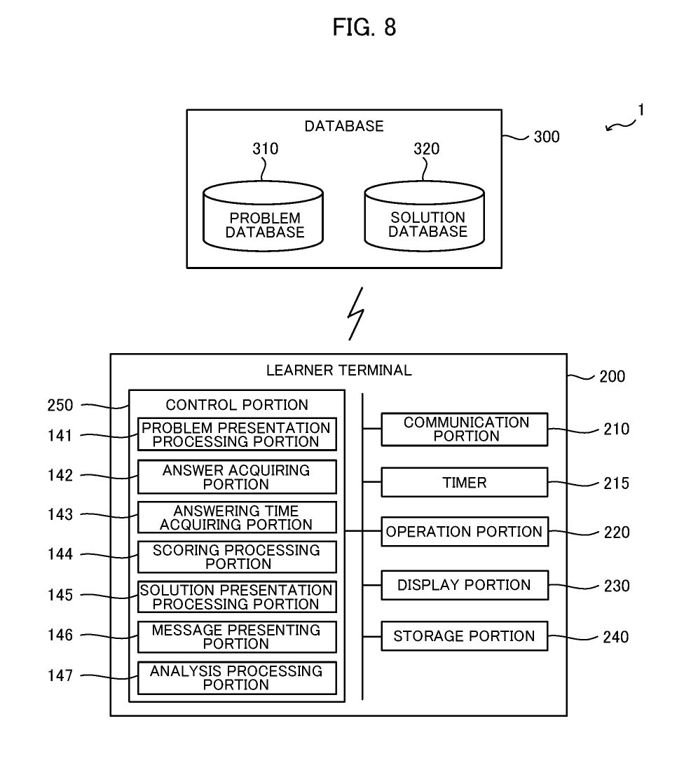

In the information processing system 1, the learner terminal 200 may have a function(s) of the information processing apparatus 100. Specifically, as shown in FIG. 8, the problem presentation processing portion 141, the answer acquiring portion 142, the answering time acquiring portion 143, the scoring processing portion 144, the solution presentation processing portion 145, the message presenting portion 146, and the analysis processing portion 147 may be included in the control portion 250 of the learner terminal 200. It is noted that in the control portion 250 shown in FIG. 8, elements that perform the same processes as the elements shown in FIG. 2 are assigned the same reference signs.

The control portion 250 controls the learner terminal 200 by allowing the CPU to execute processes in accordance with the programs stored in the storage portion or the ROM included in the learner terminal 200. The control portion 250 functions as the problem presentation processing portion 141, the answer acquiring portion 142, the answering time acquiring portion 143, the scoring processing portion 144, the solution presentation processing portion 145, the message presenting portion 146, and the analysis processing portion 147 as the CPU executes the processes in accordance with the programs stored in the ROM.

Any one or more of the problem presentation processing portion 141, the answer acquiring portion 142, the answering time acquiring portion 143, the scoring processing portion 144, the solution presentation processing portion 145, the message presenting portion 146, and the analysis processing portion 147 of the control portion 250 may be an electronic circuit(s) such as ASIC(s). The programs may be recorded on a computer-readable non-transitory recording medium, such as a CD-ROM, a DVD-ROM, or a memory card, and installed into the learner terminal 200 from the recording medium. In addition, the programs may be downloaded from a communication network such as the Internet. The programs may be stored in a server provided outside the learner terminal 200, and executed on a cloud.

It is to be understood that the embodiments herein are illustrative and not restrictive, since the scope of the disclosure is defined by the appended claims rather than by the description preceding them, and all changes that fall within metes and bounds of the claims, or equivalence of such metes and bounds thereof are therefore intended to be embraced by the claims.

1. An information processing apparatus comprising:
an answer acquiring portion configured to acquire an answer and a solution of a user to a problem;
an answering time acquiring portion configured to acquire an answering time of the user taken for the problem;
a scoring processing portion configured to score the answer; and
an information presenting portion configured to present, to the user, information which is determined based on the answering time acquired by the answering time acquiring portion, a result of scoring the answer performed by the scoring processing portion, and the solution acquired by the answer acquiring portion.

2. The information processing apparatus according to claim 1, wherein
in a case where there are a plurality of solutions to the problem,
when the answer is correct, the information presenting portion presents, to the user, a solution that is different from the solution selected by the user.

3. The information processing apparatus according to claim 2, wherein
when the answering time exceeds a reference answering time of the problem that is set in advance, the information presenting portion presents, to the user, an efficient solution that may reduce the answering time.

4. The information processing apparatus according to claim 2, wherein
when the answering time is equal to or less than a reference answering time of the problem that is set in advance, the information presenting portion presents, to the user, a first solution that is different from the solution selected by the user, and
when the answering time exceeds the reference answering time, the information presenting portion presents, to the user, the solution selected by the user and a second solution that is different from the first solution.

5. The information processing apparatus according to claim 1, wherein
in a case where there is one or no solution to the problem,
when the answer is correct and the answering time is equal to or less than a reference answering time of the problem that is set in advance, the information presenting portion presents a first message to the user, and
when the answer is correct and the answering time exceeds the reference answering time, the information presenting portion presents, to the user, a second message that is different from the first message.

6. The information processing apparatus according to claim 5, wherein
the first message is a message that praises the user, and
the second message is a message that encourages the user.

7. The information processing apparatus according to claim 1, further comprising:
an analysis processing portion configured to sum up and analyze solutions to the problem that have been respectively selected by a plurality of users including the user, wherein
the information presenting portion presents, to each of the plurality of users, a solution selected based on a result of an analysis performed by the analysis processing portion.

8. The information processing apparatus according to claim 1, further comprising:
an analysis processing portion configured to sum up and analyze solutions to the problem that have been respectively selected by a plurality of users including the user, wherein
one or more solutions associated with the problem are stored in a storage portion, and the analysis processing portion updates the solutions stored in the storage portion, based on a result of an analysis performed by the analysis processing portion.

9. An information processing method comprising:
acquiring an answer and a solution of a user to a problem;
acquiring an answering time of the user taken for the problem;
scoring the answer; and
presenting, to the user, information which is determined based on the answering time acquired, a result of the scoring the answer, and the solution acquired.

10. A non-transitory computer-readable recording medium recorded with a program that causes a computer to execute:
a step of acquiring an answer and a solution of a user to a problem;
a step of acquiring an answering time of the user taken for the problem;
a step of scoring the answer; and
a step of presenting, to the user, information which is determined based on the answering time acquired, a result of the scoring the answer, and the solution acquired.
